(19) United States
(12) Patent Application Publication
(10) Pub. No.: US 2023/0059293 A1
(43) Pub. Date: Feb. 23, 2023

(54) METHOD OF PROCESSING MICRO-HOLES OF UPPER MOLD USED FOR TRANSFERRING OR LAMINATING THIN FILM SHEETS USING FEMTOSECOND PULSED LASER BEAM

(71) Applicant: 21TH CENTURY CO., LTD., Hwaseong-si (KR)

(72) Inventors: Sung Hwan KIM, Suwon-si (KR); Hyoung Shik KANG, Hwaseong-si (KR); Dong Sub PARK, Daegu (KR)

(21) Appl. No.: 17/830,311

(22) Filed: Jun. 1, 2022

(30) Foreign Application Priority Data
Aug. 18, 2021 (KR) 10-2021-0108728

(51) Int. Cl. B23K 26/384; B23K 26/382; B23K 26/0622; B23K 26/082

(52) U.S. Cl. CPC B23K 26/384; B23K 26/082; B23K 26/389; B23K 26/0624

(57) ABSTRACT

Proposed is a method of processing micro-holes formed in an upper mold used for adsorbing, transferring, and laminating a thin structure. The micro-holes drilled by setting n mono-layers in a thickness direction of the upper mold, applying the femtosecond pulsed laser beam onto a second mono-layer in a given pattern, processing the micro-holes at a thickness of the next mono-layer in a 2D manner, and sequentially applying the femtosecond pulsed laser beam to the mono-layers while lowering a focus of the laser in units of 1 /n. The femtosecond pulsed laser beam is applied along inner surfaces of the micro-holes, thereby adjusting a dimension of a diameter of each of the micro-holes to be processed, and improving surface roughness of each of the inner surfaces of the micro-holes. Surroundings of an inlet-side edge are chamfered or rounded to prevent generation of the burrs and damage to the thin film sheet.

### CROSS REFERENCE TO RELATED APPLICATION

The present application claims priority to Korean Patent Application 10-2021-0108728, filed on Aug. 18, 2021, the entire contents of which are incorporated herein for all purposes by this reference.

### BACKGROUND OF THE INVENTION

### Field of the Invention

The present disclosure relates to a method of processing micro-holes of an upper mold used for transferring or laminating thin film sheets using an ultra-high frequency pulsed laser, especially a femtosecond pulsed laser and, more particularly, to a method of enhancing a quality of micro-holes and thus maximizing productivity based on an improvement in a processing rate by securing roundness and cylindricity while improving surface roughness of inner surfaces of the micro-holes formed in the upper mold used for separating and laminating the micro-holes formed in the upper mold used for separating and laminating the thin film sheets.

### Description of the Related Art

An upper mold, which is a vacuum plate, is used to absorb and transfer a thin film ceramic sheet, a metal thin film sheet, a thin film coating film, etc. and sequentially laminating each of them to an accurate position.

In this upper mold, micro-holes ranging from thousands to hundreds of thousands are formed to adsorb a thin film sheet, or the thin film sheet is separated by a blower. This upper mold is applied to: a laminating process of manufacturing laminated electronic components such as multilayered ceramic capacitors, multilayered ceramic varistors, multilayered ceramic actuators, or the like; a laminating process of manufacturing electronic components used to various electronic devices, inclusive of electric vehicles; and so on.

A representative example of using such an upper mold for laminating thin film sheets is illustrated in FIG. 1.

As illustrated in FIG. 1, when a thin film sheet, on which a given circuit has been formed, is adhered to an adhesive film and is then fed from an unwinding roller, an upper mold made up of a vacuum plate is brought into contact with an upper surface of the thin film sheet, and adsorbs the thin film sheet under a vacuum pressure. After performing a flaking process of cutting the thin film sheet into a given size while this upper mold is proceeding with the thin film sheet adsorbed, and then releasing the thin film sheet from the adhesive film, the adhesive film is continuously rolled in by a winding roller. On the other hand, the flaked thin film sheet is laminated on the upper surface of a lower mold made up of a laminated plate and is laminated under pressure while being separated from the upper mold.

In the upper mold used in the above process, minute holes, or micro-holes ranging from thousands of micro-holes to hundreds of thousands of micro-holes should be formed for adsorption and separation.

As a method of processing the micro-holes formed in the upper mold, a mechanical method based on a drilling machine, and a chemical method based on chemical etching are used. Both of these methods are chiefly used for the micro-holes within 150 microns because of poor surface roughness and large deviation between hole diameters.

As a concrete method of processing the micro-holes using a laser, a single pulse drilling method, a percussion pulse drilling method, a trepanning drilling method, a helical drilling method, etc. are used. Here, the trepanning drilling method is most widely used.

The trepanning drilling method is a hole processing method of applying a laser beam to the center of each micro-hole to be processed, penetrating the laser beam into the micro-hole, and turning a lower stage by a diameter of a desired micro-hole.

Even in the various drilling methods using this laser, the micro-holes formed in the upper mold are difficult to secure roughness due to burrs generated inside the micro-holes. This is because the existing trepanning drilling method is a processing method in which it is difficult to secure roundness, and which is based on fusion of a material.

Further, the micro-holes have molten protrusions and fragmented particles generated from perimeters thereof. To remove them, grinding work such as electrolytic in-process dressing is secondarily performed. Thereby, these problems seem to be solved. However, these problems are never solved in a state in which nanoscale fine particles stay on coarse surfaces of the micro-holes. This causes a problem in laminating the thin film sheet.

Especially, in the upper mold, attachment, separation, and pressurization occur at the thin film sheet more than hundreds of thousands to millions of times, which has an effect on the thin film sheet. In this case, due to the attachment/separation of the thin film sheet to/from the micro-holes from which roundness is not secured and on which suction is performed, the fine particles of the thin film sheet stay in the micro-holes from which roundness is not secured. Thus, a plugging phenomenon of the micro-holes is generated, and the fine particles existing in the micro-holes have an effect on the thin film sheet while coming off.

Due to these phenomena, a phenomenon in which the thin film sheet is pressed or torn occurs continuously, and thus is considered as a key improvement challenge in the relevant technical field.

### SUMMARY OF THE INVENTION

The present disclosure has been made to address the above problems of the prior art, and is intended to provide a method of processing micro-holes of an upper mold, in which the micro-holes formed in the upper mold for laminating a thin film sheet have little difference in diameter between an entrance side and an exit side, surface roughness of inner surfaces of the micro-holes is very low, and surfaces of the micro-holes are formed to be slanted so that tearing of the thin sheet film is not caused.

Further, the present disclosure is intended to provide a method of processing micro-holes of an upper mold, in which, when processing the micro-holes using a laser, damage to thin sheet films can be minimized by securing roundness of the micro-holes, removing fragmentary particles, and preventing generation of burrs blocking interiors of the micro-holes.

In addition, the present disclosure is intended to provide a method of machining micro-holes of an upper mold, which can perform chamfering or rounding on entrance-side shapes of the micro-holes formed in the upper mold to which an enormous load is repetitively applied.

In order to achieve at least one of the above objectives, according to one aspect of the present disclosure, provided is a method of processing micro-holes formed in an upper mold used for adsorbing, transferring, and laminating thin a film ceramic sheet, a thin film metal sheet, a coated thin film, or the like. The method may include: a step of drilling the micro-holes by setting n mono-layers (wherein n is a natural number equal to or more than 2) in a thickness direction of the upper mold, by applying the femtosecond pulsed laser to a surface of a second mono-layer in a given pattern, by processing the micro-holes to a thickness of the next mono-layer in a two-dimensional (2D) manner, and by sequentially applying the femtosecond pulsed laser to the mono-layers while lowering a focus of the laser in units of 1 /n; a boring step of applying the femtosecond pulsed laser along inner surfaces of the micro-holes, thereby adjusting a dimensional dimension of each of the micro-holes to be processed, and improving surface roughness of each of the inner surfaces of the micro-holes; and a step of chamfering or rounding surroundings of an entrance-side edge in order to prevent generation of the burrs and damage to the thin film sheet, such as a pressing phenomenon, and a tearing phenomenon that may be generated when performing the laser machining.

In this case, a pattern in which the femtosecond pulsed laser is applied to the surface of the mono-layer may be a spiral form, and the 3D shape of the femtosecond pulsed laser in the boring step may be a helical shape.

Further, the application of the femtosecond pulsed laser in the spiral form may be performed by control of mutually combining x-axial and y-axial movement of a galvanometer, and by a z-axial movement of a beam expander. It is characterized in that the helical shape may be formed under the control of mutually combining x and y axial motions of the galvanometer and a z-axial motion of the beam expander.

Here, a wavelength of the femtosecond pulsed laser may be preferably a green band of 515 mm to 532 nm in consideration of laser beam absorptivity.

Further, the chamfering or rounding processing may be performed under the control of mutually combining x and y axial motions of the galvanometer and a z-axial motion of the beam expander.

According to the method of processing micro-holes of an upper mold for laminating a thin film sheet using a femtosecond pulsed laser, which is disclosed in the present disclosure having the configuration as described above, the micro-holes formed in the upper mold have little deviation in diameter between the inlet and outlet sides thereof, the surface roughness of the inner surfaces of the micro-holes is very low, and the entrance-side edges of the micro-holes are chamfered or rounded. For this reason, the thin film sheet is not torn.

Further, according to the method of processing micro-holes using a femtosecond pulsed laser, when processing the micro-holes using the femtosecond pulsed laser, generation of molten protrusions, surface flexure, and fragmentary particles may be prevented are prevented, roundness of the micro-holes is secured, and generation of the burrs blocking the inside of the micro-holes is prevented. Thereby, a specific effect capable of minimizing damage to the thin film sheet is exerted.

### BRIEF DESCRIPTION OF THE DRAWINGS

The above and other objectives, features, and advantages of the present disclosure will be more clearly understood from the following detailed description, taken in conjunction with the accompanying drawings, in which:

FIG. 1 is a view illustrating an example of use of an upper mold for laminating thin film sheets to which a method of processing micro-holes for the present disclosure is applied;

FIG. 2 is a view illustrating an apparatus for processing micro-holes, which is used to realize the method of processing micro-holes for the present disclosure;

FIG. 3 is a view illustrating a step of drilling the micro-holes according to an embodiment of the present disclosure;

FIG. 4 is a view illustrating motions and set-up factors of a galvanometer scanner according to the drilling step illustrated in FIG. 3;

FIG. 5A illustrates a photograph in which an incoming port for the micro-holes based on the drilling method illustrated in FIG. 3 is compared with an incoming port for the micro-holes based on a conventional laser processing method, and FIG. 5B illustrates photographs of the respective outgoing ports;

FIG. 6 is a view illustrating set-up factors for 3D helical processing in the boring step according to an embodiment of the present disclosure;

FIG. 7 is a view illustrating shapes in a chamfering machining step according to the embodiment of the present disclosure;

FIG. 8 is a view illustrating shapes in the chamfering and rounding machining on a side of the incoming port for the micro-holes according to the embodiment of the present disclosure;

FIGS. 9A and 9B illustrate real photographs for comparison between shapes of the incoming and outgoing ports for the micro-holes in the processing method according to the present disclosure and shapes of incoming and outgoing ports for micro-holes in a conventional laser processing method; and

FIG. 10 is a flowchart illustrating the method of processing micro-holes step by step in the present disclosure.

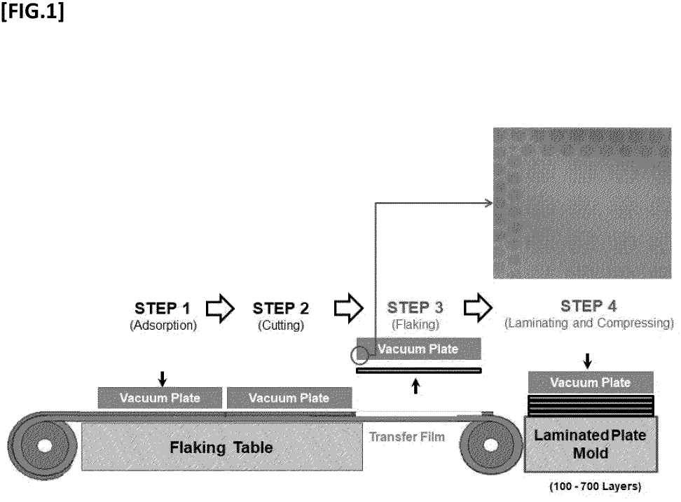

### DETAILED DESCRIPTION OF THE INVENTION

Hereinafter, preferred embodiments of the present disclosure will be described with reference to the accompanying drawings.

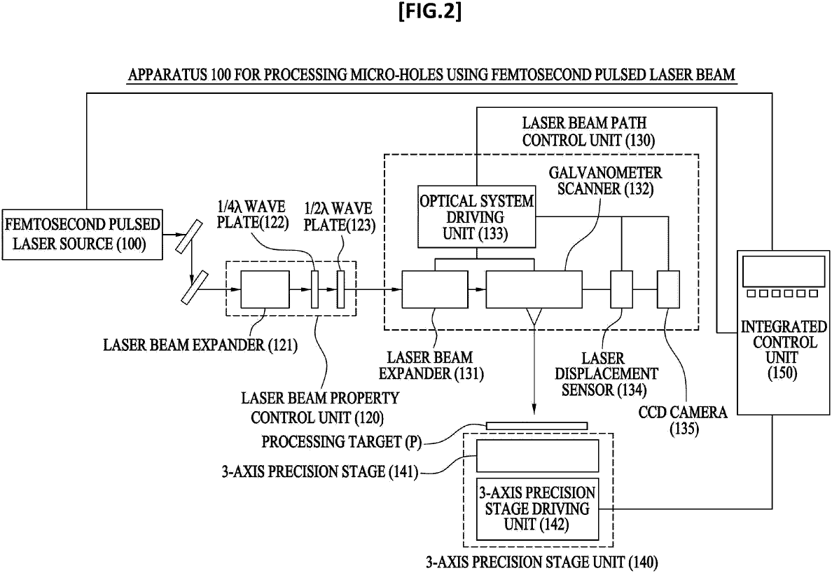

FIG. 2 is a diagram for a system illustrating a configuration of an apparatus 100 for processing micro-holes using a femtosecond pulsed laser for realizing a method of processing micro-holes of an upper mold for laminating thin film sheets using a femtosecond pulsed laser of the present disclosure.

In FIG. 2, the micro-hole processing apparatus 100 using a femtosecond pulsed laser includes a femtosecond pulsed laser beam source 110, a laser beam property control unit 120, a laser beam path control unit 130, a 3-axis precision stage unit 140, and an integrated control unit 150.

A wavelength band of the light source generating a femtosecond pulsed laser beam has a green band of 515 mm to 532 nm in consideration of a processing rate (productivity) and quality for a metal laser beam. The wavelength band may be dependent on a material of a processing target P, but is suitable for an output of 1 to 40 W in consideration of properties of the metal material of the general upper mold.

Under the control of the integrated control unit 150, the femtosecond pulsed laser beam source 110 can control a frequency and a power level (%) to change pulsed energy µJ, an average output W, and a repetition rate.

The laser beam property control unit 120 and the laser beam path control unit 130 form paths of the laser beam. The laser beam property control unit 120 is for precise adjustment of the laser beam before the laser beam generated from the femtosecond pulsed laser beam source 110 arrives at the laser beam path control unit 130, and is made up of a laser beam expander 121, a 1 /4λ wave plate 122, and a 1 /2λ wave plate 123.

The 1 /4λ wave plate 122 causes polarized light travelling along a low speed to generate a difference by 1 /4λwith respect to a fast axis for 1 /4λ, and the 1 /2λ wave plate 123 causes light travelling in a polarized light direction at a low speed to have a difference by 1 /2λwith respect to a fast axis of 1 /4λ. The laser beam expander 121 is configured to expand a diameter of an input beam to become an output beam having a required diameter.

The laser beam path control unit 130 receives the femtosecond pulsed laser beam, whose detailed adjustment has been completed, to apply the received femtosecond pulsed laser beam to the processing target P, thereby performing laser processing.

The laser beam path control unit 130 includes an active control type laser beam expander 131, a galvanometer scanner 132, and an optical system driving unit 133.

The laser beam path control unit 130 controls the number of repetitions for processing of the laser beams under the conditions under which a micro-hole processing position, a start point of 2D rotation processing, an end point of the 2D rotation processing, a Z-axis position of the 2D rotation processing, and angles and rotation speeds of the laser beams at a lowest position for the 2D rotation processing are set. Thereby, a degree of precision and quality of the processing are maximized, and the number of the whole processes is reduced, thereby improving productivity.

The active control type laser beam expander 131 performs a function of controlling a distance from the lenses to make variable focusing positions of the laser beams, and can change the distance from the lenses up to maximum ±1 mm.

Further, the galvanometer scanner 132 is configured to adjust the X and Y positions of the laser beams, and has a processible region of maximum φ2.5 mm.

The optical system driving unit 133 simultaneously controls driving of the active control type laser beam expander 131, and driving of the galvanometer scanner 132.

The laser beam path control unit 130 additionally includes a laser displacement sensor 134 for adjusting a focal distance of the laser, and a CCD camera 135 capable of identifying an unloading place and a processing start point of the processing target P, coordinates of processed micro-holes, and a processing quality in real time.

The laser displacement sensor 134 is configured to accurately sense a focal length that is a distance between the nozzle end of the galvanometer scanner and the processing target P, and to adjust the focal length. The distance from the nozzle end of the micro-hole processing apparatus 100 to the processing target P is set to 3 mm, and the laser displacement sensor 134 performs an auxiliary function capable of checking the focal length in real time.

Here, the CCD camera installed in the laser beam path control unit 130 may be used to check and inspect qualities of the micro-holes that have already processed.

Meanwhile, the 3-axis precision stage unit 140 is made up of a 3-axis precision stage to which the processing target P is placed and fixed, and a 3-axis precision stage driving unit 142.

The 3-axis precision stage driving unit 142 controls movement to the X axis, the Y axis, and the Z axis.

Further, the integrated control unit 150 performs integrated control on the femtosecond pulsed laser beam source 110, the laser beam path control unit 130, and the 3-axis precision stage unit 140.

First, the integrated control unit 150 uses software to set the above-mentioned machining parameters of the laser beam path control unit 130, set laser beam output, pulsed energy, a repetition rate, and then executes processing variables of the laser beam path control unit 130, and executes a processing path file, these pieces of data are simultaneously transferred to the optical system driving unit 133 of the laser beam path control unit 130 and the 3-axis precision stage driving unit 142 of the 3-axis precision stage unit 140.

In this case, it does not matter that, after transferring the information on the processing path control unit, the processing parameters of the laser beam path control unit 130 and the 3-axis precision stage driving unit 142 of the 3-axis precision stage unit 140 are set.

To secure work safety of the micro-hole processing apparatus 100, the integrated control unit 150 first inter-locks the femtosecond pulsed laser beam source 110 and the laser beam path control unit 130, and transfers real time information about the current state to the 3-axis precision stage unit 140. Thereby, neither laser nor scanner is set to be executed during the transfer of a 3-axis precision stage 141.

Hereinafter, the method of processing micro-holes using the femtosecond pulsed laser beam will be described.

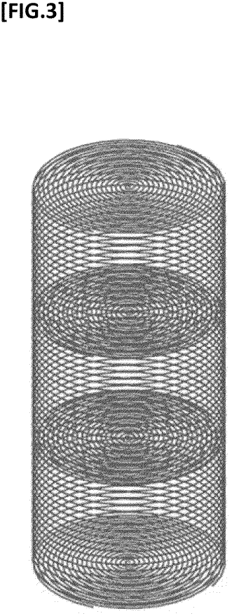

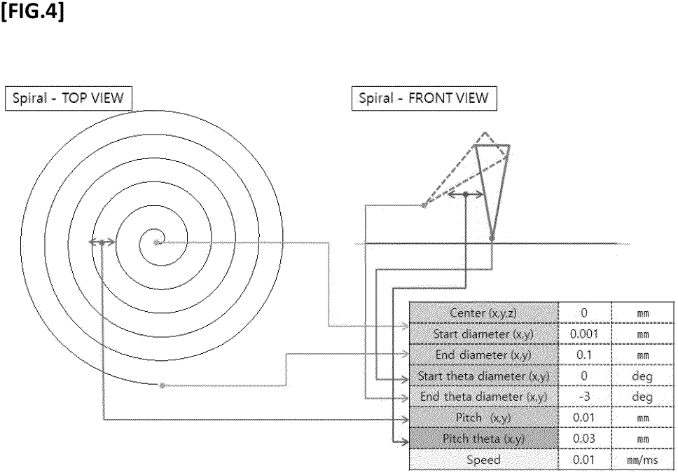

FIG. 3 is a view schematically illustrating a method of drilling micro-holes among the method of processing micro-holes using a femtosecond pulsed laser beam according to the present embodiment, and FIG. 4 is a view illustrating a screen setting conditions for performing 2D processing the micro-holes of FIG. 3.

The micro-holes of FIG. 3 are given as example that a mono-layer is partitioned to three layers in a Z-axial direction that is a height direction.

As illustrated in FIG. 4, as steps of drilling micro-holes, a total of nine processing conditions of 1) processing positions of the micro-holes with respect to a processing target 2) X and Y start points of 2D monolayer processing, 3) X and Y end points of 2D monolayer processing, 4) a Z-axial position of the 2D monolayer processing, 5) a pitch (=an interval) between X and Y for the 2D monolayer processing, 6) angles of beams for the 2D monolayer processing, 7) a pitch (=an interval) between X and Y for the 2D monolayer processing, 8) a scanning rate, and 9) a repeat count.

In forming the micro-holes illustrated in FIG. 3, a pattern of laser application selects a rough shape (or a spiral shape) of a circle, and n number (where n is the natural number more than two) of mono-layers, thereby performing 2D processing at a thickness up to the next mono-layer.

As indicated above, processing for a third mono-layer, a fourth mono-layer, ..., a n-1-th mono-layer, and a n-th mono-layer intermittently processed in turn.

In addition, as the same as the above method of processing the first mono-layer, the femtosecond pulsed laser beam is applied up to the n-th monolayer, and thereby drilling the micro-holes.

Further, by adjusting the pitch (= the interval) between the X and Y axes in the 2D processing and a Z-axial pitch (to be described below), thereby the surface roughness can be controlled.

By controlling the Z-axial pitch, according to an amount of control, setting is possible between the quality and the productivity, and adjusting the processing rate, the laser power, and the pitch (= the interval), thereby the processing is possible from several tens of nm to several tens of mm.

In the case of FIG. 3, the processing rate is 0.01 mm/ms, laser power is 3.3 W, pulsed energy is 8.3 µJ, the pitch (= the interval) between the X-axis and the Y axis in the 2D processing is 0.001 mm, and the Z-axial pitch in the 3D processing is 0.001 mm. These are conditions for forming a high quality of micro-hole.

In this manner, the whole holes are not processed using a single focal distance, but the whole holes are partitioned into n mono-layers, constant energy is applied for each mono-layer while moving downward the focal point with respect to each mono-layer. Thereby, the holes, each of which has a given depth, can be processed.

Unlike the present invention, if the processing is uniformly performed in a state in which the focal point is fixed on the basis of an arbitrary point that exists on the surfaces or the interiors of the holes is fixed, energy density is considerably changed in proportion to the distance from the focus of the laser beam. Fused metal residuals are inevitably generated. Because the molten metal residuals that are hardened in a left state, a quality of processing, as well as the shapes and sizes of the holes are not constant, the plate in which several tens of thousands of holes are formed cannot be used as the vacuum plate.

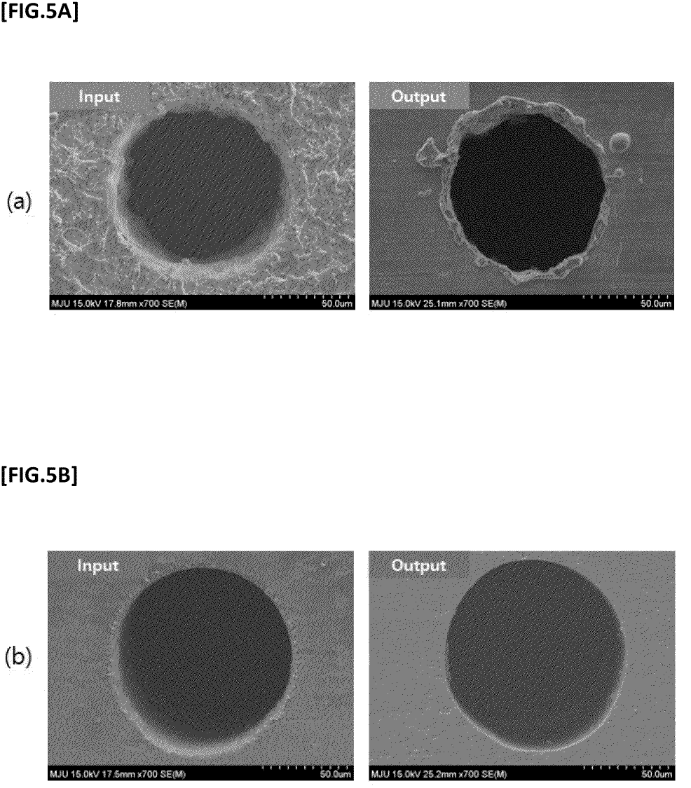

FIG. 5A is a photograph directly showing a state of the micro-holes that are processed without a change or adjustment of the focal point by a method generally used for processing micro-holes, and FIG. 5B illustrates real photographs of the micro-holes that are processed by the method of processing micro-holes using the femtosecond pulsed laser beam.

As can be checked in FIG. 5A, if holes whose diameters are less than 100 um are processed without a change in the focus point, the input-side diameter and the output-side diameter are different from each other. Particularly, it can be checked that the shapes of the output-side holes cannot be possibly used for adsorption and transfer of the thin-film sheets due to metal residuals.

On the other hand, it can be checked that the micro-holes processed using the method of processing micro-holes using a femtosecond pulsed laser beam in accordance to the present embodiment are very smooth, and have little difference.

That is, according to the method of processing micro-holes using a femtosecond pulsed laser beam, when n mono-layers that have already set is intermittently processed, because the focal points of the laser beam depending on each of the mono-layers are different become constant regardless of a difference in depths of the corresponding mono-layers, a state to which the entire micro-holes are processed become uniform, no molten residuals are generated while heat generation is minimized in view of properties of the femtosecond pulsed laser beam, no damage on the thin-film sheet even in an environment in which tons to tens of tons of load are applied without a deviation difference between the diameter sizes of the holes from several hundred of thousand times to several million times.

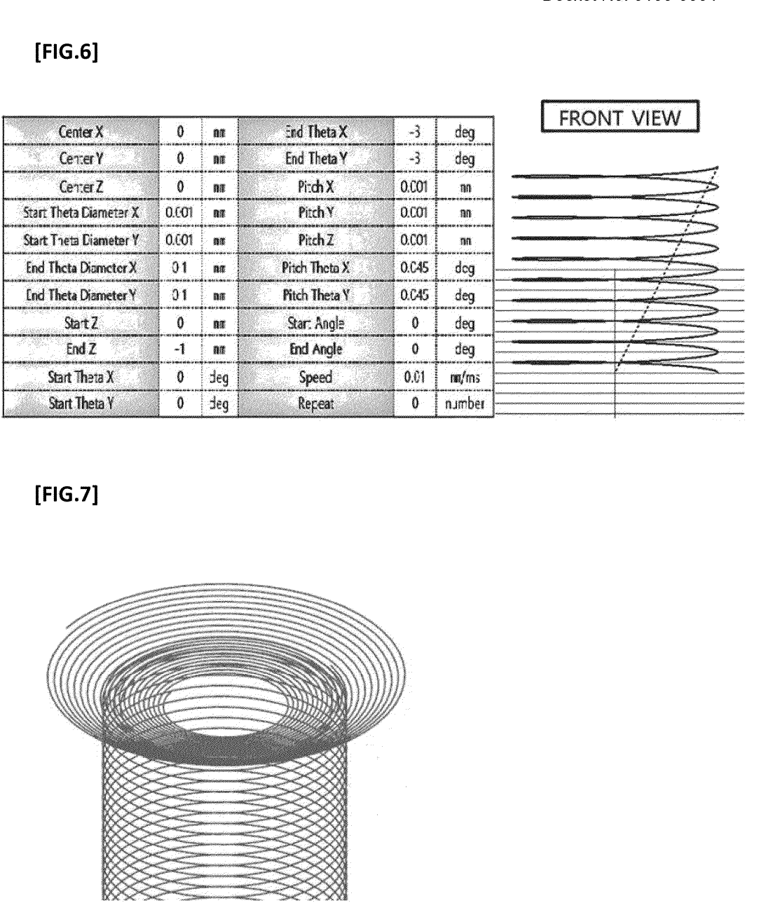

FIG. 6 is a view illustrating a set-up window for processing conditions and paths for the femtosecond pulsed laser beam in the boring processing process after the above-described process of drilling the micro-holes.

In addition to the intermittent sequential process of the above-described mono-layers, the method of drilling micro-holes which is described above is characterized by a boring process for improving surface roughness of the hole inner surface and a degree of precision of the diameter.

As illustrated in FIG. 6, the boring process is performed by controlling a 3D shape a combined motion between a galvanometer scanner 132 and an active control type laser beam expander 131 by going through a total of six setting processes including 1) processing positions of the micro-holes, 2) start and end points (which are equal to each other) on a top-plane view for 3D shape processing, 3) a Z-axial start point for 3D shape processing, 4) a Z-axial end point for 3D shape processing, 5) a scanning rate, and 6) set-up of repetition rate.

That is, the boring process is immediately and continuously performed as a concept of being performed after passing through an immediately cutting process capable of compared to rough cutting.

This boring process is a helical shaped 3D processing having a pitch in the Z-axial direction unlike the mono-layer processing as the 2D processing.

Because the boring process of the present disclosure performs a process along a 3D helical locus using a femtosecond pulsed laser beam, it is possible to adjust both a degree of precision and a work time. Particularly, the boring process is suitable for mass production.

FIG. 7 is a view showing a state in which a chamfering or rounding process is performed around an inlet port side (an upper surface side) for the micro-holes using the femtosecond pulsed laser beam.

The chamfering or rounding process of FIG. 7 may be performed by a control of a combined motion toward X-, Y-, and Z-axes, and may sequentially processed with respect to each axis.

The chamfering or rounding process for edges adjacent to the inlet side for the micro-holes is such an approaching method that even an approach cannot be made in a field in which an upper mold used for adhesion or transfer is manufactured.

Because the micro-holes formed in the upper mold are minute holes in units of micron and are numbered from several tens of thousands to several millions, it is impossible for the micro-holes to be realistically subjected to a chamfering or rounding process. As a result, the method of processing micro-holes using a femtosecond pulsed laser beam is performed, whose method can be performed on combination control of the X-axis, Y-axis, and Z-axis.

As described above, processes performed after numerous micro-holes are drilled in the past are as follows. Here, uniform grinding work is only performed on the entire area in order to remove metal burrs from the inlet side. However, the metal burrs are not removed by this uniform grinding work, and rather the metal burrs resulted in blocking the inlets of the micro-holes. Edges of the inlet side for the micro-holes are inevitably sharp. For this reason, when the thin film sheet is adhered and transferred, or released, the thin film sheet is torn or cut due to the sharpness of the edges of the inlet side for the micro-holes. These problems are not solved.

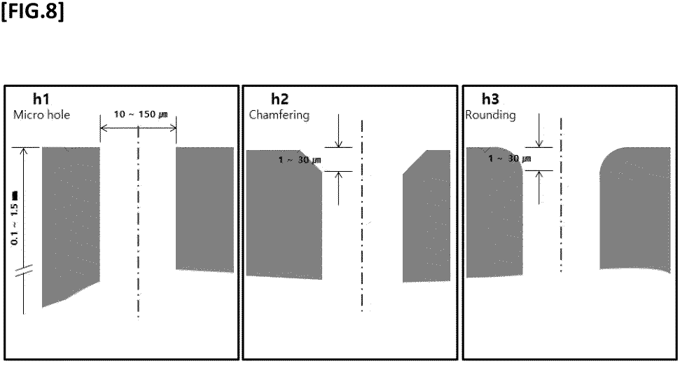

FIG. 8 is a view illustrating an inlet-side shape for the micro-holes that can be formed by a chamfering or rounding process of the present disclosure, wherein h1 shows a state in which micro-holes are drilled without the chamfering or rounding process, h2 shows a state in which the chamfering process is performed on the inlet side for the micro-holes, and h3 shows a state in which the rounding process is performed on the inlet side for the micro-holes.

As illustrated in FIG. 8, because the inlet side of h1 is formed with very sharp edges, the thin film sheet is torn or cut when the thin film sheet is sucked toward the micro-holes. However, the inlet side of h2 or h3 can suppress damage of the thin film sheet to the utmost because a load is distributed.

In the present embodiments, it has been described that the chamfering or rounding process was performed after the drilling and the boring for the micro-holes. However, it is natural that after the chamfering or rounding process, the drilling and the boring may be performed.

As process conditions when the chamfering or rounding process is performed, output of the femtosecond pulsed laser is 3 to 25 W, a repetition rate is 100 to 200 kHz, pulse energy is 10 to 40 µJ, an interval between the pitches of the driving beam of the galvanometer scanner is 0.001 to 0.01 mm, and a scan rate is 1 to 50 mm/s.

Especially, in the driving method of processing perimeters of the holes through a plurality of laser motions after the micro-holes h1 of FIG. 8 are formed, output of the femtosecond pulsed laser is 3 to 20 W, a repetition rate is 100 to 200 kHz, pulse energy is 10 to 30 µJ, an interval between the pitches of the driving beam of the galvanometer scanner is 0.001 to 0.01 mm, and a scan rate is 10 to 100 mm/s.

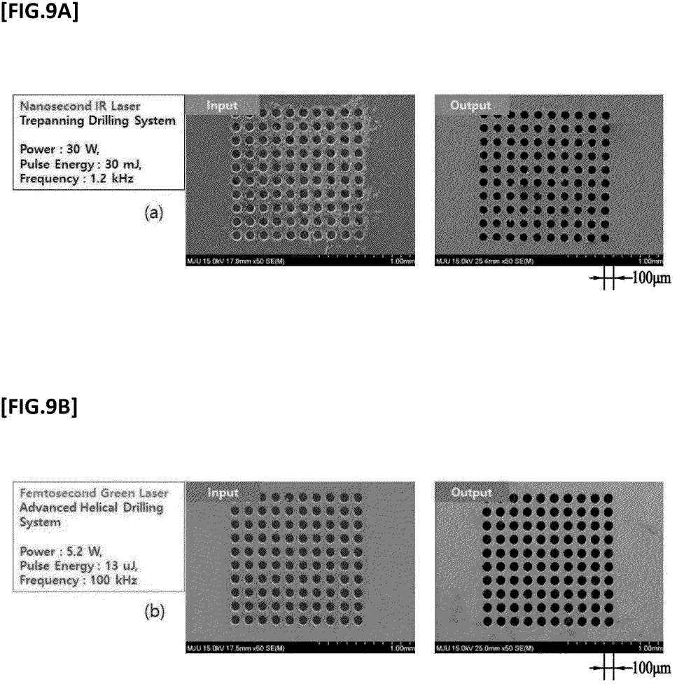

FIG. 9A is a real photograph illustrating states of the inlet and outlet sides for the micro-holes formed by a general conventional laser, and FIG. 9B is a real photograph illustrating the micro-holes of vacuum plates processed by the method of processing the micro-holes using a femtosecond pulsed laser in the present disclosure.

As can be checked from the photographs of FIGS. 9A and 9B, the micro-holes illustrated in FIG. 9A are micro-holes that are processed by a laser that has a pulse width in units of nanometer and has been widely used in the past. Here, a change in diameter between the inlet side and the outlet side is great, molten metal residues considerably exist inside and outside the micro-holes. Due to the sharp edges of the inlet side, the thin film sheet can be hardly used for adhesion and transfer, and separation thereof. In contrast, the micro-holes illustrated in FIG. 9B are micro-holes that are based on the processing method using the femtosecond pulsed laser according to the present disclosure. Here, it can be checked that there is no difference between the inlet side and the outlet side, that the molten metal residues are hardly observed, that the thin film sheet cannot be torn or cut because tempering or rounding is formed at the edges of the inlet side.

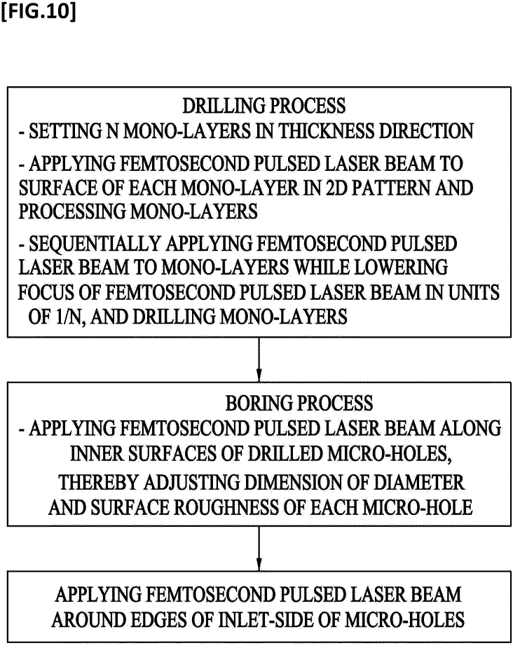

FIG. 10 is a flowchart illustrating the method of processing micro-holes using a femtosecond pulsed laser according to the present disclosure step by step. Here, detailed conditions for each step have been described above, and thus duplicate description thereof will be omitted.

Up to now, the method of processing micro-holes using a femtosecond pulsed laser according to the present disclosure has been described by means of the preferred embodiments. However, this is intended to help understanding of the present disclosure, and is not intended to limit the scope of the present disclosure.

It is obvious to those skilled in the art that various changes in form or design, or substitution may be made without departing from the spirit and scope of the invention.

For example, in the step of drilling the micro-holes, each mono-layer is formed in a two-dimensional (2D) manner. Here, the shape of each micro-hole is not necessarily limited to a circular shape, and may have various cross section for the micro-hole, such as an oval shape, a quadrilateral shape, and so on. When sequentially processed for each mono-layer, a method of drilling the micro-holes using 2D processing in a doughnut shape will be possible.

In addition, in the chamfering or rounding process, it is very natural that dimensions of chamfering or filleting are variously changed as needed.

What is claimed is:

1. A method of processing micro-holes formed in an upper mold used for adsorbing, transferring, and laminating a thin film ceramic sheet, a thin film metal sheet, a thin coating film, or the like, the method comprising:
a step of drilling the micro-holes by setting n mono-layers in a thickness direction of the upper mold, where n is a natural number equal to or more than 2, by applying the femtosecond pulsed laser beam to a surface of a second mono-layer in a given pattern, by processing the micro-holes at a thickness of the next monolayer in a two-dimensional manner, and by sequentially applying the femtosecond pulsed laser beam to the mono-layers while lowering a focus of the laser in units of 1 /n;
a boring step of applying the femtosecond pulsed laser beam along inner surfaces of the micro-holes, thereby adjusting a dimension of a diameter of each of the micro-holes to be processed, and improving surface roughness of each of the inner surfaces of the micro-holes; and
a step of chamfering or rounding surroundings of an inlet-side edge in order to prevent generation of the burrs and damage to the thin film sheet, such as a pressing-down phenomenon, a tearing phenomenon, or a cutting phenomenon that are generated when performing the laser processing.

2. The method according to claim 1, wherein the pattern in which the femtosecond pulsed laser beam is applied to the surface of the mono-layer is a spiral form having a given pitch, and the 3D shape of the femtosecond pulsed laser beam is a helical shape.

3. The method according to claim 2, wherein the application of the femtosecond pulsed laser beam in the helical shape is made through a control of mutually combining X and Y axial motions of a galvanometer, and the pattern of the helical shape is made through a control of combining the X and Y axial motions of the galvanometer and a Z-axial motion of a beam expander.

4. The method according to claim 1, wherein a wavelength of the femtosecond pulsed laser beam has a green region band of 515 nm to 532 nm in consideration of a heat absorption rate.
